(19) United States
(12) Patent Application Publication
(10) Pub. No.: US 2007/0245701 A1
(43) Pub. Date: Oct. 25, 2007

(54) Filter structure attached by magnets

(76) Inventor: Steven Su, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/409,002

(22) Filed: Apr. 24, 2006

(51) Int. Cl. B01D 46/00

(52) U.S. Cl. 55/490

(57) ABSTRACT

The present invention concerns a filter structure attached via magnets. The filter structure includes a filter body and a magnetic unit. The magnetic unit is attached to the filter body. According to the needs of the user, the filter structure can be disposed or added to any desired place of a device. The filter structure prevents dust and particles in the air from entering the device. Thereby, the device may continue to work normally.

### BACKGROUND OF THE INVENTION

1. Field of the Invention

The present invention relates to a filter structure, and more particularly, to a filter structure attached by magnets so that the filter can be easily mounted and dismounted.

2. Description of the Related Art

A heat sink device of a host generally takes heat from the host through an airflow produced by a fan to keep the host working normally. But there is a large number of dust and particles in the airflow. There is also a lot of conductible material in the dust and particles. If such material enters into the host on a large scale, the host will be shut down. Therefore, a filter is usually disposed in the host for filtering out the dust and particles to prevent the dust and particles from building up in the host. As a result of such filtering, the host can work normally.

A filter structure of the prior art, as shown in FIG. 1, includes a filter body 10a, a fan 20a, and a plurality of screws 30a. The filter body 10a includes a frame 11a and a plurality of meshes 12a. The meshes 12a are integrated with the frame 11a. The frame 11a has a plurality of through holes 13a for fixing. The fan 20a has a plurality of corresponding fixing holes 21a. The screws 30a penetrate the through holes 13a and the fixing holes 21a for fixing the filter body 10a to the fan 20a. The filter body 10a filters the dust and the particles out through the meshes 12a. Air from outside should be filtered first through the filter body 10a, before then entering into the inner portion of the fan 20a.

However, the filter structure of the prior art is limited in its applications. The filter structure only can be disposed on a device having a plurality of fixing holes 21a via a plurality of corresponding screws 30a. Therefore, the filter structure can't be disposed on another device if a user so wishes.

### SUMMARY OF THE INVENTION

It is therefore a principal object of the present invention to provide a filter structure that is attached via magnets. According to the needs of a user, the filter structure can be disposed or added to any desired place on a device. The filter structure prevents dust and particles in the air from entering into the device in order to keep the device working normally. The present invention has been accomplished to eliminate the aforesaid problem.

To achieve the above object, one feature of the present invention is provided for a filter structure attached via magnets, that includes a filter body and a magnetic unit. The magnetic unit is attached to the filter body.

To achieve the above object, another feature of the present invention is provided for a filter structure attached via magnets, that includes a mainframe, a magnetic unit and a filter body. The mainframe has at least one radiating portion. The filter body is magnetically attached to at least one corresponding radiating portion of the mainframe through the magnetic unit.

To provide a further understanding of the invention, the following detail description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a composition view of a conventional filter structure attached with a fan.

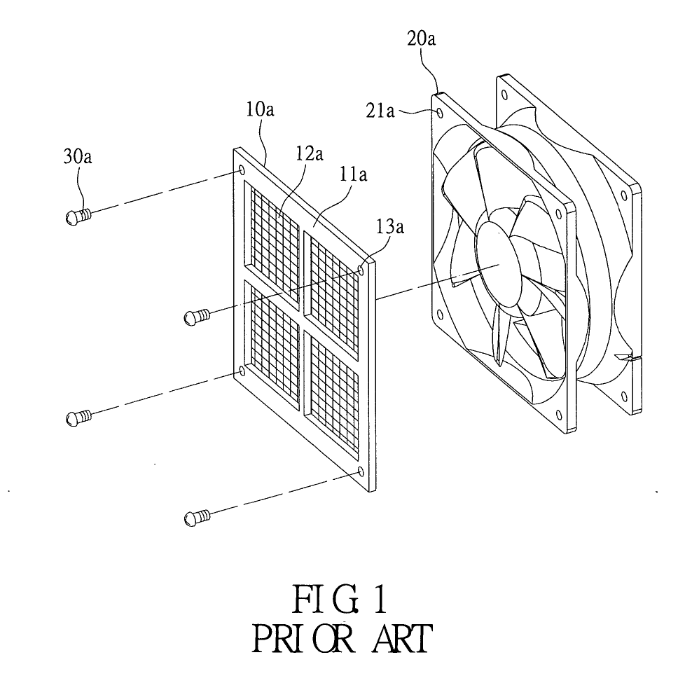

FIG. 2 is a composition view of the first preferred embodiment of the present invention.

FIG. 3 is composition view of the first preferred embodiment of the present invention attached with a sideboard of a casing.

FIG. 4 is a composition view of the second preferred embodiment of the present invention.

FIG. 5 is composition view of the second preferred embodiment of the present invention attached with a fan.

FIG. 6 is a composition view of the third preferred embodiment of the present invention.

FIG. 7 is a composition view of the fourth preferred embodiment of the present invention.

FIG. 8 is a composition view of the fifth preferred embodiment of the present invention.

### DETAILED DESCRIPTION OF THE EMBODIMENTS

Referring now to the drawings wherein the showings are for purposes of illustrating preferred embodiments of the present invention only, and not for purposes of limiting the same.

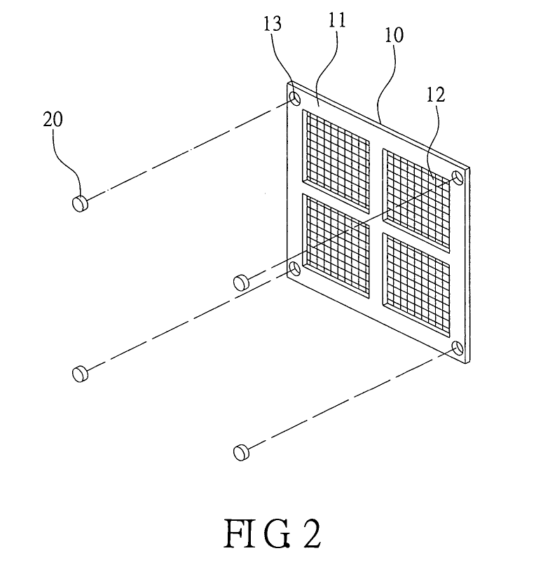

Referring to the FIG. 2. The present invention provides a filter structure attached via magnets. The filter structure includes a filter body 10 and a magnetic unit 20.

The filter body 10 has a frame 11 and a plurality of meshes 12. The frame 11 assumes a square-shape. The meshes 12 are integrated with the frame 11. The meshes 12 have a function of allowing ventilation and filtering.

The frame 11 has at least one receiving portion 13 at each corner thereof for receiving the magnetic unit 20. The receiving portion 13 has two openings respectively at two ends thereof.

The magnetic unit 20 is a plurality of permanent magnets. Each of the permanent magnets assumes a circle-shape. Each of the permanent magnets is pressed in and received in the corresponding receiving portion 13, so that the magnetic unit 20 combines with the filter body 10. Both a front end and a rear end of the filter body 10 can be magnetically attached to a desired setting place or device through the magnetism of the magnetic unit 20.

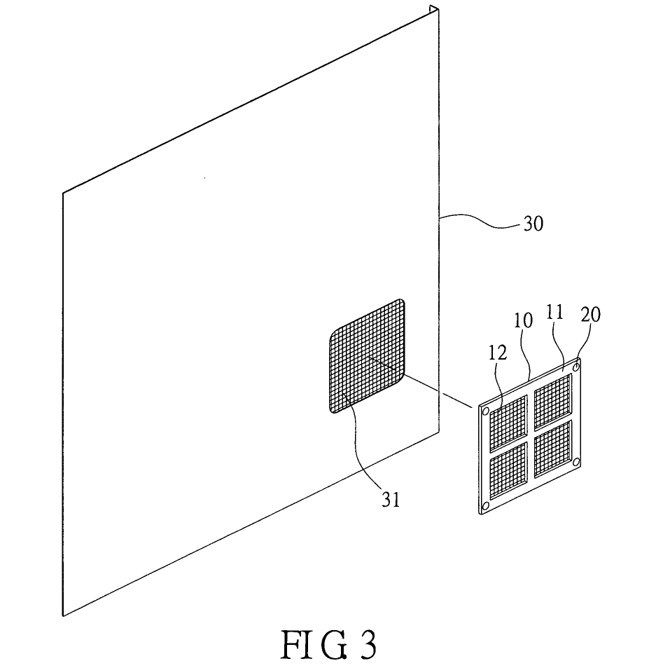

Referring to FIG. 3. A sideboard 30 of a casing is made of iron. The sideboard 30 has a radiating portion 31 so that air may enter. The radiating portion 31 assumes a square-shape. One side of the filter body 10 is magnetically attached to an outer surface of the sideboard 30 through the magnetic unit 20, so that the sideboard 30 forms a filter structure. When the air outside of the sideboard 30 wants to enter the casing, it will pass through the meshes 12 of the filter body 10 first. After filtering the dust and particles through the meshes 12, the air can pass through the radiating portion 31 of the sideboard 30 and enter the casing. Therefore, the filter body 10 prevents dust from entering the inner portion of the casing. After a period of time, the meshes will store up a large number of dust and particles. At that time, the filter body 10 should be removed from the sideboard 30 for cleaning. After cleaning, the filter body 10 could be magnetically attached to the sideboard 30 again. Therefore, the filter body 10 with the magnetic unit 20 can mounted on or dismounted from the sideboard 30 quickly and easily.

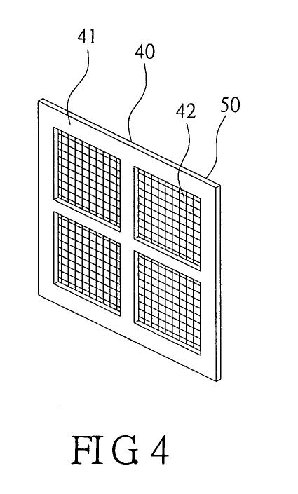

Referring to FIG. 4. The filter structure attached via magnets includes a filter body 40 and a magnetic unit 50. The filter body 40 has a frame 41 and a plurality of meshes 42. The meshes 42 are integrated with the frame 41 for filtering air. The frame 41 is made of a magnet or an electromagnet. The magnetic unit 50 is integrated with the frame 41 of the filter body 40. The filter body 40 can magnetically attach to an iron setting place or an iron device through the magnetic unit 50.

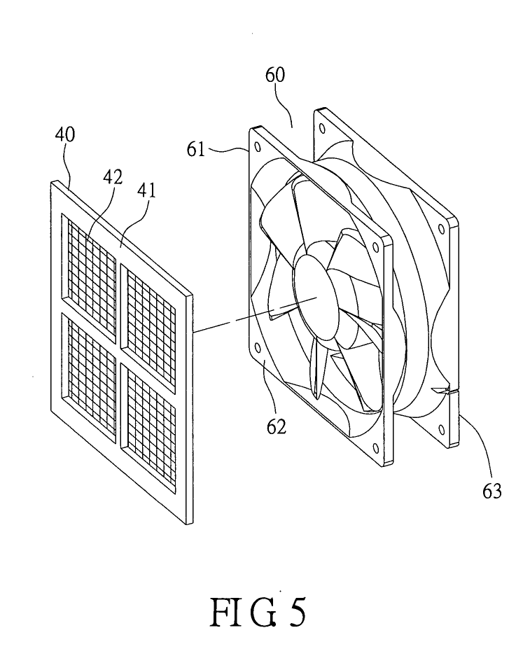

Referring to FIG. 5. The filter body 40 can be attached to a fan 60. The fan 60 includes an iron frame 61. The frame 61 has a front side and a corresponding rear side. The frame 61 defines an air inletting face 62 at the front side thereof. The frame 61 defines an air exhausting face 63 at the rear side thereof. The filter body 40 attaches to the air inletting face 62 of the fan 60 at one side thereof. The dust and particles in air are filtered through the meshes 42 of the filter body 40. The meshes 42 stop dust and particles from entering the fan 60, so that the fan 60 can turn smoothly. For the same reason, the filter body 40 can also be attached to the air exhausting face 63 for filtering out the dust and particles in air.

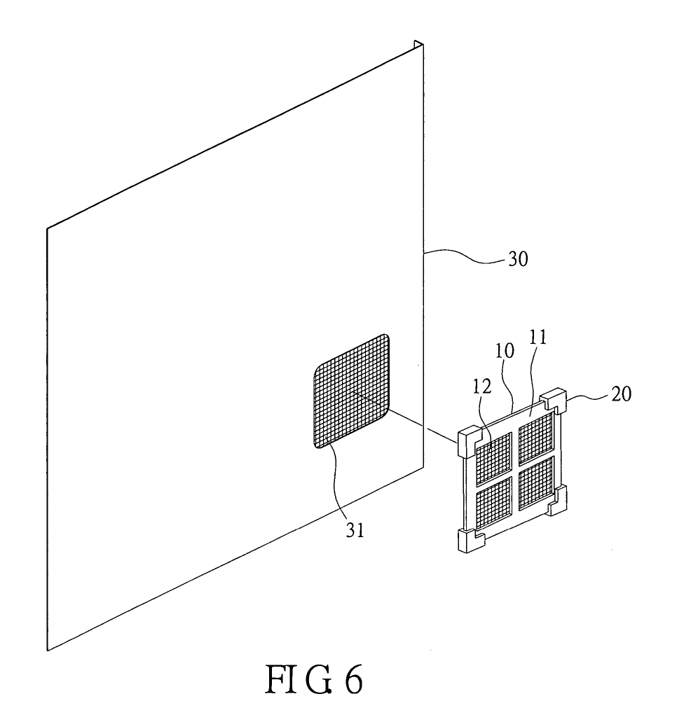

Referring to FIG. 6. The magnetic unit 20 includes four magnets. Each of four magnets assumes a L-shaped. And each of four magnets mounts to each corner of the filter body 10 by the way of inlaying. The filter body 10 magnetically attach to the radiating portion 31 of the sideboard 30 through the magnetism of the magnetic unit 20.

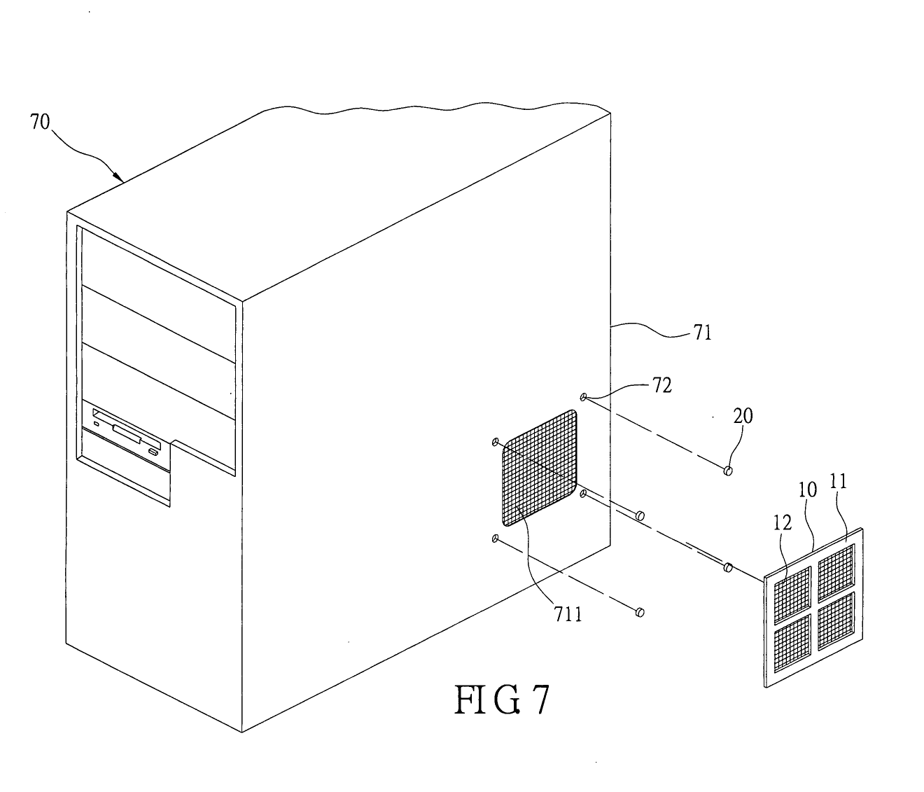

Referring to FIG. 7. The filter structure attached via magnets includes a mainframe 70, a magnetic unit 20 and a filter body 10. The mainframe 70 could be a power supply, a redundant power supply, a personal computer, an industrial personal computer, a server, an uninterruptible power supply, an external redundant array of independent disk box, a hard disk external box, an external CD-ROM box, a key board, a heat-sink plate of a laptop computer, a projector, or a medical measuring/testing equipment. In this preferred embodiment, the mainframe 70 is a personal computer. The mainframe 70 has a casing 71. The casing 71 has four receiving portions 72 and a radiating portion 711. The four receiving portions 72 are near the setting place of the radiating portion 711. Each of the four receiving portions 72 is circle-shaped. Each of the four receiving portions 72 has two openings respectively at two ends thereof.

The magnetic unit 20 includes four permanent magnets. Each of the four permanent magnets are respectively pressed in or received in the corresponding receiving portion 72, so that the magnetic unit 20 can be combined with the casing 71 of the mainframe 70.

The frame 11 of the filter body 10 is made of iron or inlaid with at least one piece of iron therein, so that the filter body 10 can be magnetically attached to the corresponding radiating portion 711 of the mainframe 70.

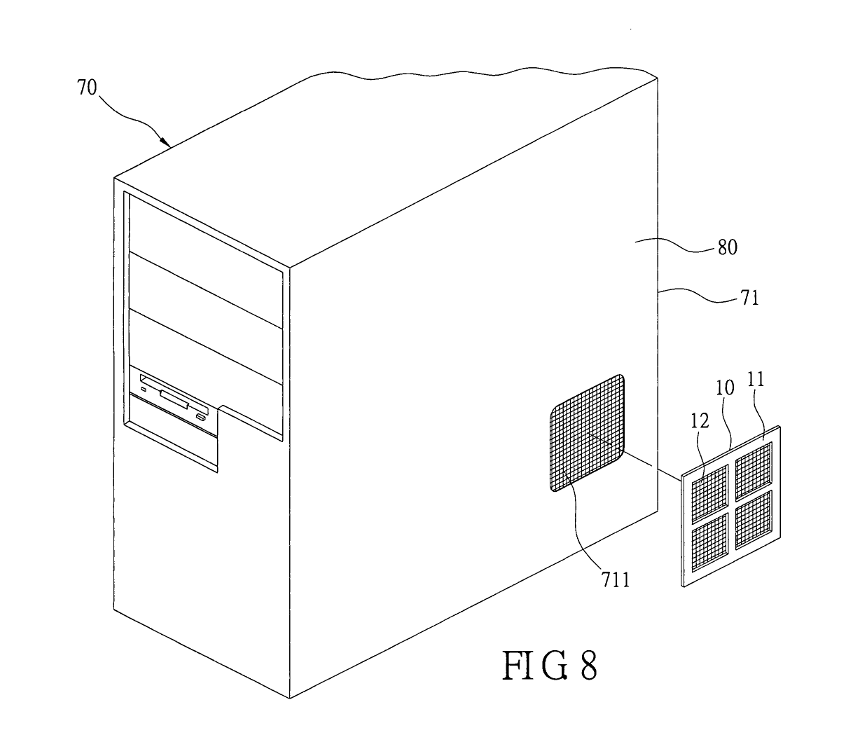

Referring to FIG. 8. The casing 71 is made of a magnet or an electromagnet. The magnetic unit 80 is integrated with the casing 71 of the mainframe 70. The filter body 10 with the iron frame 11 can be magnetically attached to the corresponding radiating portion 711 of the mainframe 70 through the magnetism of the magnetic unit 80.

Therefore, the filter structure of the present invention can be more easily and quickly mounted on and dismounted from a device than the filter structure of the prior art. It is unnecessary to set a fixing hole for the filter structure of the present invention. Instead, the filter structure can be directly magnetically attached to a device which needs a filter structure. The device could be a casing of a power supply, a redundant power supply, a personal computer, an industrial personal computer, a server, an uninterruptible power supply, an external redundant array of independent disk box, a hard disk external box, an external CD-ROM box, a key board, a heat-sink plate of a laptop computer, a projector, a medical measuring/testing equipment or other products having a filter. As such, we can say that the present invention has a wide range of applications. It provides the user the freedom to dispose the filter upon any desired place. Furthermore, it is easily dismounted for cleaning and has good adaptability. It is easily manufactured, so that the cost of manufacture is reduced.

There has thus been described a new, novel and heretofore unobvious filter structure attached via magnets eliminating the aforesaid problem of the prior art. Furthermore, those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A filter structure attached via magnets, comprising:
a filter body; and
a magnetic unit attached to the filter body.

2. The filter structure attached via magnets of claim 1, wherein the filter body further includes at least one receiving portion for receiving the magnetic unit.

3. The filter structure attached via magnets of claim 1, wherein the filer body further includes a magnetic frame, the magnetic unit being combined with the frame of the filter body.

4. The filter structure attached via magnets of claim 1, wherein the magnetic unit comprises at least one permanent magnet.

5. The filter structure attached via magnets of claim 1, wherein the magnetic unit comprises at least one electromagnet.

6. The filter structure attached via magnets of claim 1, wherein the magnetic unit comprises at least one magnet.

7. A filter structure attached via magnets, comprising:
a mainframe having at least one radiating portion;
a magnetic unit; and
a filter body magnetically attached to the at least one corresponding radiating portion of the mainframe through the magnetic unit.

8. The filter structure attached via magnets of claim 7, wherein the mainframe is a power supply, a redundant power supply, a personal computer, an industrial personal computer, a server, an uninterruptible power supply, an external redundant array of independent disk box, a hard disk external box, an external CD-ROM box, a key board, a heat-sink plate of a laptop computer, a projector, or a medical measuring/testing equipment.

9. The filter structure attached via magnets of claim 7, wherein the mainframe further includes at least one receiving portion for receiving the magnetic unit.

10. The filter structure attached via magnets of claim 7, wherein the mainframe further includes a magnet casing, the magnetic unit being combined with the casing of the mainframe.

11. The filter structure attached via magnets of claim 7, wherein the magnetic unit comprises at least one permanent magnet.

12. The filter structure attached via magnets of claim 7, wherein the magnetic unit comprises at least one electromagnet.

13. The filter structure attached via magnets of claim 7, wherein the magnetic unit comprises at least one magnet.

14. The filter structure attached via magnets of claim 7, wherein the magnetic unit is combined with the mainframe.

15. The filter structure attached via magnets of claim 7, wherein the filter body has an iron frame.

16. The filter structure attached via magnets of claim 7, wherein the filter body has a frame that includes at least one piece of iron.
